(19) United States
(12) Patent Application Publication
(10) Pub. No.: US 2016/0379261 A1
(43) Pub. Date: Dec. 29, 2016

(54) TARGETED CONTENT USING A DIGITAL SIGN

(71) Applicant: INTEL CORPORATION, SANTA CLARA, CA (US)

(72) Inventors: Jose A. Avalos, Chandler, AZ (US); Addicam V. Sanjay, Gilbert, AZ (US); Shweta Phadnis, Chandler, AZ (US); Archana Rajendran, Tempe, AZ (US)

(73) Assignee: INTEL CORPORATION, SANTA CLARA, CA (US)

(21) Appl. No.: 14/752,435

(22) Filed: Jun. 26, 2015

(51) Int. Cl. G06Q 30/02

(52) U.S. Cl. CPC G06Q 30/0261

(57) ABSTRACT

Disclosed herein is a computer system for rendering targeted content on a digital sign. The computer system includes a display screen and a camera. The computer system also includes a video analytics module to receive video images from the camera and generate audience metrics based on the video images. The audience metrics include eye gaze information that identifies an area of the display screen being viewed by a person. The computer system also includes a content management module to identify a content selection to be rendered by the digital sign based on the audience metrics.

### TECHNICAL FIELD

The present disclosure relates to techniques for generating targeted media content based on information gathered about a one or more people in the vicinity of a digital sign.

### BACKGROUND ART

The term “digital signage” generally refers to the use of electronic display devices to provide advertising, announcements, or other types of information to the public. Digital signage is often displayed in public venues such as restaurants, shopping malls, sporting arenas, amusement parks, and the like. Digital signage enables advertisers to display advertising content that is more engaging and dynamic. The advertisers can also easily change the content in real time based on changing conditions, such as the availability of new promotions, the time of day, weather conditions, and other data. In this way, advertising content can be more effectively targeted to the specific demographics of the people viewing it.

### BRIEF DESCRIPTION OF THE DRAWINGS

FIG. 1 is a block diagram of an example system configured to implement the techniques described herein.

FIG. 2 is an example of an implementation of the system described in FIG. 1.

FIG. 3 is another example of an implementation of the system described in FIG. 1

FIG. 4 is a process flow diagram summarizing a method of operating a digital sign.

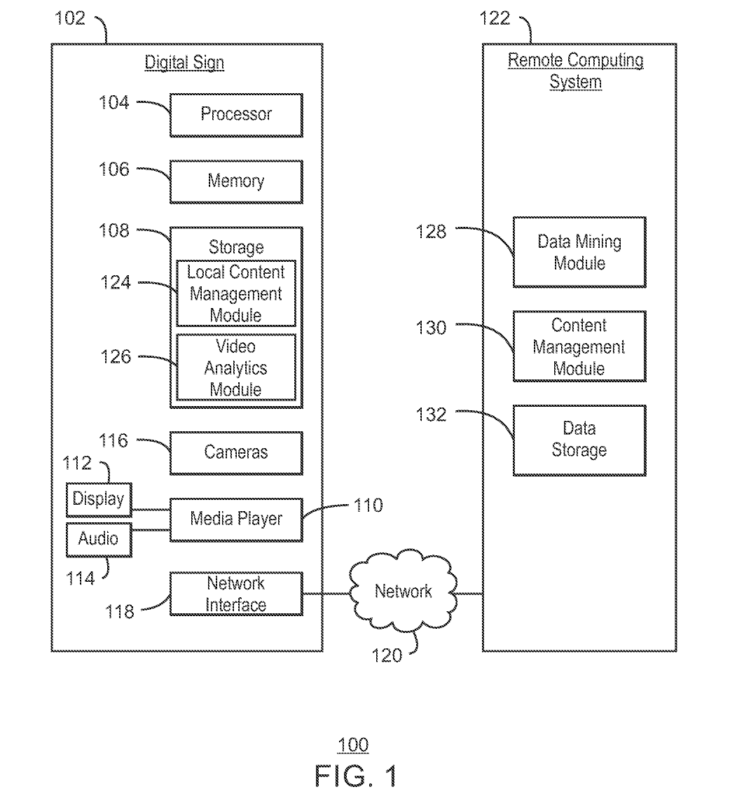

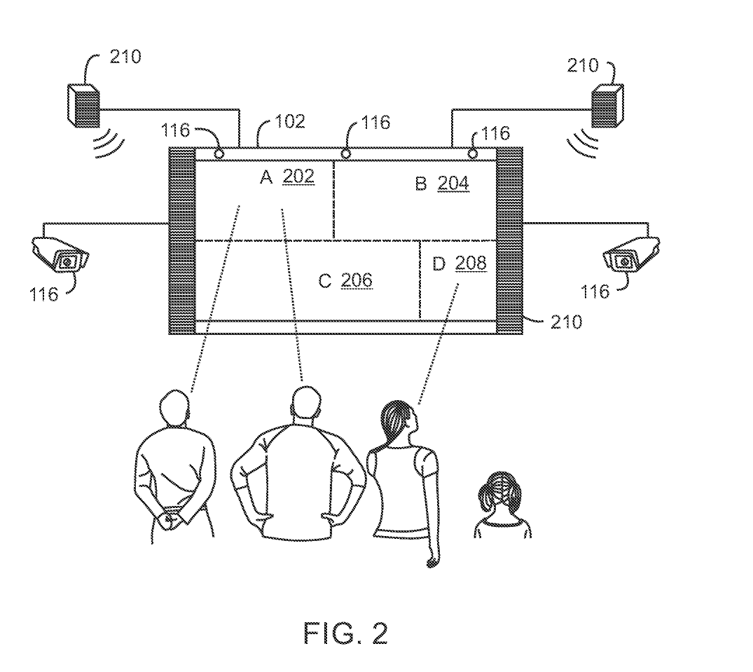

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The present disclosure provides techniques for placing targeted media content such as advertisements in a digital sign. The techniques described herein provide a system to gather information about the people in the vicinity of a digital sign and provide advertising or other media that is more likely to capture people's interest. The information gathered will be anonymous. For example, the collected information may include the number of people gathered in a specific area and demographic information about the people, such as age and gender. One type of information that can be collected is the eye gaze of individual people. The eye gaze is an indication of the direction in which person's eyes appear to be directed. Using the eye gaze information, the system can automatically determine what content a person is currently viewing. This and other data can be used to identify possible viewer interests, which can be used to identify media more likely to be of interest to the viewer or viewers.

The techniques described herein can be used for placing advertisements in digital sign based, at least in part, on what one or more people are viewing. The techniques described herein can also be used to automatically identify audio media to play based on a demographic information of a group of people.

FIG. 1 is a block diagram of an example system configured to implement the techniques described herein. The system 100 includes a digital sign 102. The digital sign 102 may configured to present any type of content, menu items, advertisements, train schedule or flight status information, pricing information, entertainment, music, and others. The digital sign may be deployed in any type of setting, including a restaurant, a shopping mall, sports arena, or airport, for example.

The digital sign 102 includes a processor 104 that is adapted to execute stored instructions, as well as a memory 106 that stores instructions that are executable by the processor 104. The processor 104 can be a single core processor, a multi-core processor, or any number of other configurations. The memory 106 can include random access memory (RAM), such as Dynamic Random Access Memory (DRAM), or any other suitable memory type. The memory 106 can be used to store data and computer-readable instructions that, when executed by the processor, direct the processor to perform various operations in accordance with embodiments described herein.

The digital sign 102 can also include a storage device 108. The storage device 108 is a physical memory such as a hard drive, an optical drive, a solid-state drive, an array of drives, or any combinations thereof. The storage device 108 may also include remote storage devices. Content to be rendered by the digital sign, such as audio, video, and image files, may be stored to the storage device 108.

The digital sign 102 also includes a media player 110, a display 112, and an audio system 114. The display 112 may be any suitable type of display type, including Liquid Crystal Display (LCD), Organic Light Emitting Diode (OLED), Plasma, and others. In some examples, the digital signs can include multiple displays, each of which may be configured to display the same content or different content. The display 112 and the audio system 114 may be built-in components of the digital sign 102 or externally coupled to the digital sign 102.

The digital sign 102 can also include one or more cameras 116 configured to capture still images or video. The cameras 116 may be built-in components of the digital sign 102 or externally coupled to the digital sign 102. Images or video captured by the camera 116 can be analyzed by one or more programs executing on the digital sign 102 to generate various information about people in the vicinity of the digital sign 102.

In some examples, the digital sign 102 includes a network interface 118 configured to connect the digital sign through to a network 120. The network 120 may be a wide area network (WAN), local area network (LAN), or the Internet, among others. Through the network, the digital sign 102 can connect to a remote computing system 122. The remote computing system 122 can include various modules used to identify content to be rendered by the digital sign 102. The remote computing system 122 can include any suitable type of computing system, including one or more desktop computers, server computers, or a cloud computing system, for example.

Together, the digital sign 102 and the remote computing system 122 coordinate to identify characteristics of the people in the vicinity of the digital sign and then identify targeted content to be rendered by the digital sign 102. The digital sign 102 can include various programming modules to enable it to identify characteristic of people and coordinate the rendering of media content, including a local content management module 124 and a video analytics module 126. The video analytics module 126 analyzes images captured by the cameras 116 and generates information about the people in the vicinity of the display. The information generated by the video analytics module 126 about the people in the vicinity of the display is referred to herein as audience metrics.

The video analytics module 126 can identify people, determine whether a person is male or female, and determine an approximate age of a person. The video analytics module 126 can also analyze facial features and determine the direction of a person's eye gaze. The direction of a person's eye gaze can be used to determine what the person is viewing, such as what part of the digital sign a person is viewing. The audience metrics can include information such as the number of people in the vicinity of the display, how many people are looking at the digital sign, and the mix of ages and genders in the vicinity of the display. The audience metrics can also include information about the viewership of visual content being displayed by the digital sign 102. For example, in the case of a sign displaying three different advertisements, the video analytics module 126 might determine that eight people are near the sign, that one person is viewing a first advertisement, three people are viewing a second advertisement, and nobody is viewing the third advertisement. The video analytics module 126 could also determine that the person viewing the first advertisement is female, while the three people viewing the second advertisement are male. The video analytics module 126 can also capture the time of day and length of time that a person has viewed particular content. The audience metrics captured by the video analytics module 126 can be sent to the remote computing system 122 via the network 120 for further analysis.

The local content management module 124 coordinates the rendering of content by the digital sign 102 and can record information about what content was rendered, the time of day that the content was rendered, the duration of the content rendering, and where the content was rendered, for example, which portion of the digital sign's display 112. This information about the rendered contents can be referred to herein as playlist information. The local content management module 124 can send the playlist information the remote computing system 122 via the network for further analysis.

The remote computing system 122 receives the audience metrics and the playlist information, analyzes the data and send content recommendations back to the digital sign 102. In some examples, remote computing system 122 includes a data mining module 128, a content management module 130, and a data storage system 132. The content management module 130 communicates with the local content management module 124 on the digital sign 102. For example, the content management module 130 can send content recommendations to the local content management module 124. A content recommendation can include an identification of media file to be rendered, a location of the rendering, and other information. The local content management module 124 can render the recommended content immediately or place the recommended content in a queue for future rendering.

The data mining module 128 receives the playlist data from the local content management module 124 and also receives the audience metrics from the video analytics module 126. The data mining module 128 can then analyze the information to generate rules based on statistical correlations between the rendered content and the audience metrics. For example, a specific advertisement may be of more interest to younger males. Analysis of the audience metrics, including eye gaze analytics, may indicate that during the rendering of the advertisement, the majority of people viewing the advertisement are young and male. Analysis of the audience metrics may also indicate that during certain hours of the day, fewer people tend to view the advertisement, while at other times of day more people tend to view the advertisement. Such correlations can be used by the data mining module 128 to generate rules. To continue with the above example, the data mining module 128 may generate a rule that states the advertisement should be shown during a certain time of day, or when the current audience is composed of a certain number or certain percentage of young males, or some combination of the time of day and the audience composition. The data mining module 128 may also identify similar content and create rules that refer to the similar content. For example, a rule may identify a range of media files.

The data mining module 128 can send the rules to the content management module 130. The content management module 130 can monitor the current audience metrics received from the video analytics module 126 and identify content to be rendered based on the rules. In some examples, the content to be rendered may be an advertisement intended to be of interest to a particular segment of the people in the vicinity of the sign. In some examples, the content to be rendered may be entertainment media intended to appeal to a particular segment of the people in the vicinity of the sign, such as a music selection. For example, a particular rule may identify a particular type of music to play or particular music selections to play based on the age of most of the people in the vicinity of the sign.

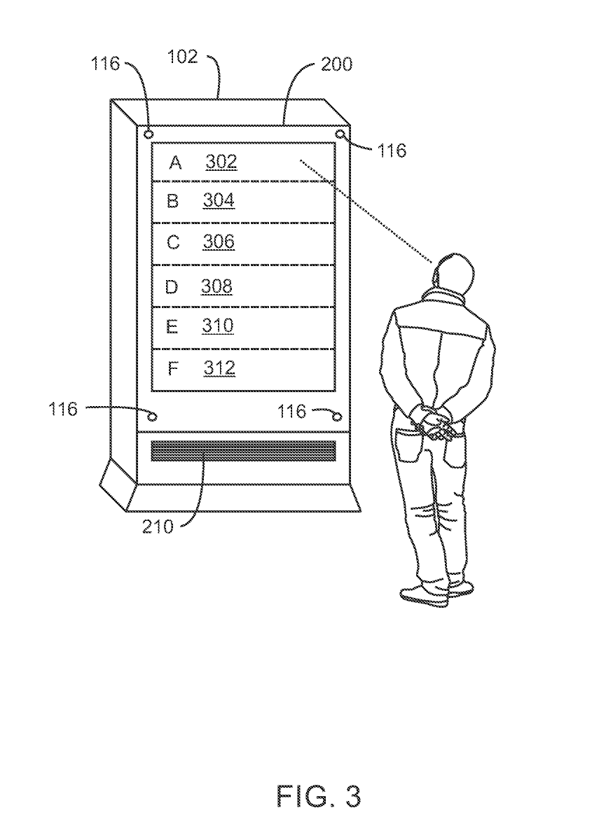

The data mining module 128 can send the rules to the content management module 130. The content management module 130 uses the rules to determine content to be rendered by the digital sign 102. The acquired audience metrics, playlist data, and data generated by the data mining module 128, such as the rules, may be stored to a data storage system 132. In some examples, media content may also be stored to the data storage system 132 and transferred to the digital sign 102. Examples of particular implementations of the system 100 are described in more detail in relation to FIGS. 2 and 3.

It will be appreciated that the particular system shown in FIG. 1 is an example implementation of the techniques disclosed herein, and that other implementations are also possible. For example, in some implementations, one or more of the data mining module 128, the data mining module 128, the content management module 130, and the data storage system 132 may reside locally on the digital sign 102.

FIG. 2 is an example of an implementation of the system described in FIG. 1. FIG. 2 shows a digital sign 102 in a retail establishment such as a restaurant. The digital sign 102 has a display screen 200 that is divided into four portions that are configured to display different content. The portions are referred to herein as portion A 202, portion B 204, portion C 206, and portion D 208. It will be appreciated that the particular configuration shown FIG. 2 is only one example, and that the display screen 200 may be divided into any number of portions of varying size and shape depending on the visual design specified by the user. Additionally, the visual design may also change in response to new design parameters, the content being displayed, and other factors.

The digital sign 102 also includes cameras 116 and speakers 210, which form a part of the audio system 114 shown in FIG. 1. Additional cameras 116 and speakers 210 may be external components coupled to the digital sign 102. In some examples, the audio system 114 may be distributed throughout the establishment. As shown in FIG. 1, the digital sign 102 may be coupled to a remote computing system 122 through a network 120. The analysis of audience metrics and selection of content can be performed by the digital sign 102, by the remote computing system, or some combination thereof.

The digital sign 102 analyses the images captured by the cameras 116 to determine audience metrics. In this example, the digital sign 102 is able to determine that there are four people in the vicinity of the digital sign 102, and determines the ages and genders of the people. Based on the audience metrics generated by digital sign 102, content can be identified that has a greater likelihood of appealing to a large portion of the audience. For example, the identified content may be an advertisement for a particular offering that has been determined to appeal to a certain age group. The advertisement can include visual content that is displayed on a portion the display screen 200 and/or audio content that is played through the speakers 210.

Content can also be identified based on the eye gaze of the audience. The example of FIG. 2 shows that two of the audience members are viewing portion A 202 and one person is viewing portion D 208. The digital sign 102 can also measure the length of time that each person has been viewing each portion. Based on these audience metrics. The digital sign 102 can identify portion A 202 as having the greatest audience attention at that moment and can select content related to the subject matter of portion A 202. For examples, portion A 202 may be a part of a menu that shows desert items. In response, the digital sign 102 may select a video advertisement related to deserts and begin displaying the advertisement in another portion of the display screen 200. The digital sign 102 can also identify a portion of the display screen 200 that is not currently being viewed be anyone and render the content on that portion of the display screen 202. For example, portion B 204 is not currently being viewed. Therefore, the digital sign 102 can select portion B 204 as the portion were the desert advertisement is rendered.

In some examples, the digital sign 102 can evaluate the success of the content selection by continuing to monitor the audience response. For example, the digital sign 102 can monitor whether members of the audience shifted there gaze to the new content and how long their gaze remained on the new content. This information can be used to generate a measure of success for the selection.

In some examples, the establishment may want to provide a pleasing atmosphere for patrons, such as by playing music. The audience metrics gathered by the digital sign 102 can be used to identify a musical selection that will have a greater likelihood of appealing to the patrons within the establishment. The music selection may be determined based at least in part on the age data collected for the people in the establishment. For example, if the audience metrics indicate that a majority of the people in the establishment fit within a certain age group, a music selection that has been identified as being popular within that age group can be selected for rendering through the establishment's audio system. Other audience metrics can also be used to identify a musical selection, including gender and others.

FIG. 3 is another example of an implementation of the system described in FIG. 1. FIG. 3 shows a digital sign 102 in a public area such as a shopping mall or an airport, for example. In this example, the digital sign 102 is implemented in the style of a kiosk, which has a display screen 200, cameras 116, and speakers 210. As shown in FIG. 1, the digital sign 102 may be coupled to a remote computing system 122 through a network 120. The analysis of audience metrics and selection of content can be performed by the digital sign 102, by the remote computing system, or some combination thereof.

The display screen 200 of FIG. 3 is divided into six portions labeled A 302 through F 312. Each portion can be configured to display different content. Additionally, the number, size, and shape of the portions 302 through 312 can change depending on the content being displayed. The digital sign 102 can vary the content on a periodic basis and/or in response to the audience metrics collected by the digital sign 102. The digital sign 102 analyses the images captured by the cameras 116 to determine audience metrics.

In this example, the digital sign 102 is configured to render content based at least in part on which portion of the display screen 200 is currently being viewed. As shown in FIG. 3, there is currently a single person viewing the display screen. Audience metrics can be collected for this person, including age, gender, and the like, and content can be selected for rendering based on the audience metrics. For example, the selected content may be content that has been identified as being more appealing to people of the same gender and age group.

Additionally, the digital sign 102 may also select content based in part on the persons eye gaze. For example, content can be selected based on which portion a person is viewing and the length of time that they have been viewing a particular portion. In this example, the person is viewing portion A 302 and has maintained eye contact with portion A 302 for a substantial amount of time, which indicates an interest in the subject matter being rendered in portion A 302. Accordingly, the digital sign 102 may render additional content that is also related to the same subject matter as currently being displayed in portion A 302. The new content can be rendered in one or more of the other portions 304 to 312. For example, portion A 302 may displaying an advertisement for airline travel. If it is determined that the person has maintained his eye gaze on portion A for a sufficient amount of time, portion C 306 and portion D may be combined and used for displaying an additional advertisement related to air travel. For example, the new content may feature specific vacation destinations. The digital sign 102 can determine whether the audience member switched his gaze to the new content to determine whether the content selection was successful.

The new content may be a different type of content compared to the original content that attracted the viewer's attention. For example, the content displayed in portion A may be a still image, while the new content displayed in portions C and D may be video content, which may be accompanied by audio. In some examples, the new content is audio only and is rendered through the speakers 210 while the display screen remains unaffected.

By monitoring the eye gaze of audience members, the digital sign 102 can collect audience metrics that can be used to determine which content attracts the most attention. For example, the digital sign 102 can track the number of people that have viewed particular content over a certain time frame, the combined amount of time that content has been viewed by audience members, the audience demographics of those that have viewed specific content, and the like. This data can be processed, for example, by the data mining module 128 (FIG. 1) to identify effective content and generate associations between specific content and demographic features of the audience members that tend to view the content.

Although a single audience member is present in the example shown in FIG. 3, it will be appreciated that the techniques described in relation to FIG. 3 also apply for multiple audience members. In cases wherein multiple people are viewing a portion of the display screen 200, the selection of new content can be based on the viewing status of the majority of audience members, or new content can be selected for individual audience members or sub-groups of audience members.

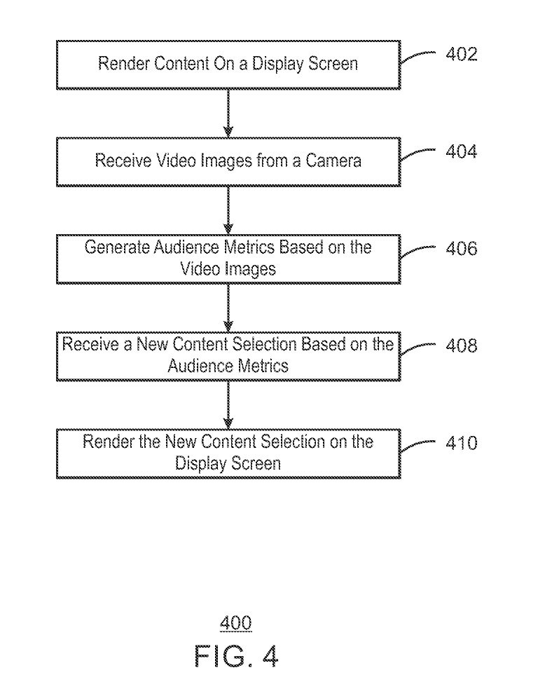

FIG. 4 is a process flow diagram summarizing a method of operating a digital sign. The method 400 is performed by hardware or a combination of hardware and software. For example, the method 400 can be performed by one or more processors reading instructions stored on a tangible, non-transitory, computer-readable medium. The method 400 can also be performed by one or more logic units, such as an Application Specific Integrated Circuit (ASIC), a Field Programmable Gate Array (FPGA), or an arrangement of logic gates implemented in one or more integrated circuits, for example. Some or all of the actions described in relation to the method 400 can be performed by hardware components of the digital sign. In some examples, some of the actions, such as collecting the audience metrics, are performed by hardware components of the digital sign while other actions may be performed by components of a remote computer system.

At block 402, content is rendered on a display screen. As explained above, the content can be menu items, advertisements, travel information, and the like.

At block 404, video images are received from a camera. The camera may be included in the digital sign or coupled to the digital sign. The video images are images of the area around the digital sign and are intended to capture images of the people in the vicinity of the digital sign.

At block 406, audience metrics are generated based on the video images. The audience metrics can include any information about the audience, such as the number of audience members, the age and gender of the audience members. Audience metrics can also include eye gaze information that identifies an area of the display screen being viewed by a person, the content being viewed, the amount of time that content is being viewed, the number of people viewing each content item, and the like. The audience metrics, including the eye gaze information and the length of time that certain portion of the display screen has been viewed, can be used to assign a level of interest for the content displayed in the relevant portion of the display screen. In some examples, the audience metrics are sent to a remote system for further analysis.

At block 408, a content selection is received, the content selection being identified based on the audience metrics. In some examples, the content selection is identified by a component of a remote system, such as the data mining module 128 of FIG. 1, and received by the digital sign from the remote system. In some examples, the content selection is identified locally and a component of the digital sign receives the content selection from another component of the digital sign without the assistance of a remote system. The content selection can include image data and/or audio data. For example, the content selection can include a musical selection identified as being popular with a demographic present in a vicinity of the digital sign as indicated by the audience metrics.

The content selection can be selected based on a portion of the display screen that is being viewed by a greater number of people as indicated by the audience metrics. For example, the content selection may be an advertisement related to content being displayed on a portion of the display screen and viewed by one or more people. The content selection can also include multiple content items. For example, the content selection may include two or more advertisements to be displayed in different portions of the display screen, wherein each advertisement has been identified as being likely to appeal to a group of people in a vicinity of the digital sign as indicated by the audience metrics.

At block 410, the identified content is rendered by the digital sign. Rendering can include displaying the content on the display screen, playing the content through an audio system, or both. In some examples, the digital sign identifies a portion of the display screen not being viewed by anyone based on the eye gaze information and renders the content selection in that portion of the display screen.

Blocks 402 to 410 may be repeated, for example, on a periodic basis, in response to new content being rendered, or in response to a changing audience profile. The audience metrics collected during future iterations may be used to evaluate the effectiveness of the rendered content at targeting audience interests. For example, after rendering the new content selection, the digital sign can determine whether a person whose interests are being targeted shifts their gaze to the new content selection. This information can be used to determine whether the content selection was successful at appealing to the targeted people.

It is to be understood that the process flow diagram of FIG. 4 is not intended to indicate that the blocks of the method 400 are to be executed in any particular order, or that all of the blocks are to be included in every case. Further, any number of additional blocks may be included within the method 400, depending on the specific implementation.

### Examples

Example 1 is a computer system for rendering targeted content on a digital sign. The computer system includes a display screen; a camera; and a video analytics module to receive video images from the camera and generate audience metrics based on the video images. The audience metrics include eye gaze information that identifies an area of the display screen being viewed by a person. The computer system of example 1 also includes a content management module to identify a content selection to be rendered by the digital sign based on the audience metrics.

Example 2 includes the computer system of example 1, including or excluding optional features. In this example, the content selection includes a musical selection identified as being popular with a demographic present in a vicinity of the digital sign as indicated by the audience metrics.

Example 3 includes the computer system of any one of claims 1 to 2, including or excluding optional features. In this example, the content selection is to be selected based on a portion of the display screen that is being viewed by a greater number of people.

Example 4 includes the computer system of any one of claims 1 to 3, including or excluding optional features. In this example, the content selection includes two or more advertisements to be displayed in different portions of the display screen, each advertisement identified as being likely to appeal to a group of people in a vicinity of the digital sign as indicated by the audience metrics.

Example 5 includes the computer system of any one of claims 1 to 4, including or excluding optional features. In this example, the digital sign is to identify a portion of the display screen not being viewed by anyone based on the eye gaze information and render the content selection in the portion of the display screen not being viewed.

Example 6 includes the computer system of any one of claims 1 to 5, including or excluding optional features. In this example, the computer system is to measure a length of time that a portion of the display screen is viewed and, based at least in part on the length of time, assign a level of interest in content being displayed in the portion of the display screen.

Example 7 includes the computer system of any one of claims 1 to 6, including or excluding optional features. In this example, the computer system is to render the content selection and determine whether a targeted person shifts their gaze to the content selection to determine whether the content selection was successful at appealing to the targeted person.

Example 8 includes the computer system of any one of claims 1 to 7, including or excluding optional features. In this example, the computer system is to record a number of views and a viewing time for each content selection rendered by the digital sign.

Example 9 includes the computer system of any one of claims 1 to 8, including or excluding optional features. In this example, the content selection is an advertisement related to content being displayed on a portion of the display screen.

Example 10 includes the computer system of any one of claims 1 to 9, including or excluding optional features. In this example, the video analytics module resides on the digital sign and the content management module resides on a remote computing system coupled to the digital sign through a network.

Example 11 is a non-transitory computer-readable medium. The non-transitory computer-readable medium includes instructions that direct the processor to render content on a display screen; receive video images from a camera; and generate audience metrics based on the video images. The audience metrics include eye gaze information that identifies an area of the display screen being viewed by a person. The non-transitory computer-readable medium also includes instructions that direct the processor to send the audience metrics to a remote system to identify a new content selection based on the audience metrics; and render the new content selection on the display screen.

Example 12 includes the non-transitory computer-readable medium of example 11, including or excluding optional features. In this example, the new content selection is a musical selection identified as being popular with a demographic present in a vicinity of the digital sign as indicated by the audience metrics.

Example 13 includes the non-transitory computer-readable medium of any one of claims 11 to 12, including or excluding optional features. In this example, the new content selection is to be selected based on a portion of the display screen that is being viewed by a greater number of people.

Example 14 includes the non-transitory computer-readable medium of any one of claims 11 to 13, including or excluding optional features. In this example, the new content selection comprises two or more advertisements to be displayed in different portions of the display screen, each advertisement identified as being likely to appeal to a group of people in a vicinity of the digital sign as indicated by the audience metrics.

Example 15 includes the non-transitory computer-readable medium of any one of claims 11 to 14, including or excluding optional features. In this example, the non-transitory computer-readable medium includes instructions to identify a portion of the display screen not being viewed by anyone based on the eye gaze information and render the new content selection in the portion of the display screen not being viewed by anyone.

Example 16 includes the non-transitory computer-readable medium of any one of claims 11 to 15, including or excluding optional features. In this example, the non-transitory computer-readable medium includes instructions to measure a length of time that a portion of the display screen is viewed, wherein a level of interest is assigned for content displayed in the portion of the display screen based at least in part on the length of time.

Example 17 includes the non-transitory computer-readable medium of any one of claims 11 to 16, including or excluding optional features. In this example, the non-transitory computer-readable medium includes instructions to render the new content selection and determine whether a targeted person shifts their gaze to the new content selection to determine whether the new content selection was successful at appealing to the targeted person.

Example 18 includes the non-transitory computer-readable medium of any one of claims 11 to 17, including or excluding optional features. In this example, the non-transitory computer-readable medium includes instructions to record a number of views and a viewing time for each content selection rendered by the digital sign.

Example 19 includes the non-transitory computer-readable medium of any one of claims 11 to 18, including or excluding optional features. In this example, the new content selection is an advertisement related to content being displayed on a portion of the display screen and viewed by at least one person.

Example 20 includes the non-transitory computer-readable medium of any one of claims 11 to 19, including or excluding optional features. In this example, the non-transitory computer-readable medium includes instructions to send the audience metrics to a data mining module residing on the remote system, wherein the data mining module identifies the new content selection based in part on previously collected audience metrics.

Example 21 is a method of rendering targeted content on a digital sign. The method includes rendering content on a display screen; and receiving video images from a camera; generating audience metrics based on the video images. The audience metrics include eye gaze information that identifies an area of the display screen being viewed by a person. The method also includes receiving a new content selection based on the audience metrics; and rendering the new content selection on the display screen.

Example 22 includes the method of example 21, including or excluding optional features. In this example, the new content selection is a musical selection identified as being popular with a demographic present in a vicinity of the digital sign as indicated by the audience metrics.

Example 23 includes the method of any one of claims 21 to 22, including or excluding optional features. In this example, the new content selection is to be selected based on a portion of the display screen that is being viewed by a greater number of people as indicated by the audience metrics.

Example 24 includes the method of any one of claims 21 to 23, including or excluding optional features. In this example, the new content selection includes two or more advertisements to be displayed in different portions of the display screen, each advertisement identified as being likely to appeal to a group of people in a vicinity of the digital sign as indicated by the audience metrics.

Example 25 includes the method of any one of claims 21 to 24, including or excluding optional features. In this example, the method includes identifying a portion of the display screen not being viewed by anyone based on the eye gaze information and rendering the new content selection in the portion of the display screen not being viewed by anyone.

Example 26 includes the method of any one of claims 21 to 25, including or excluding optional features. In this example, the method includes measuring a length of time that a portion of the display screen is viewed, and assigning a level of interest for content displayed in the portion of the display screen based at least in part on the length of time.

Example 27 includes the method of any one of claims 21 to 26, including or excluding optional features. In this example, the method includes rendering the new content selection and determining whether a targeted person shifts their gaze to the new content selection to determine whether the new content selection was successful at appealing to the targeted person.

Example 28 includes the method of any one of claims 21 to 27, including or excluding optional features. In this example, the method includes recording a number of views and a viewing time for each content selection rendered by the digital sign.

Example 29 includes the method of any one of claims 21 to 28, including or excluding optional features. In this example, the new content selection is an advertisement related to content being displayed on a portion of the display screen and viewed by at least one person.

Example 30 includes the method of any one of claims 21 to 29, including or excluding optional features. In this example, the method includes sending the audience metrics to a data mining module residing on a remote system, wherein the data mining module identifies the new content selection based in part on previously collected audience metrics.

Example 31 is a digital sign for rendering targeted content. The digital sign for rendering targeted content includes logic to render content on a display screen; logic to receive video images from a camera; and logic to generate audience metrics based on the video images. The audience metrics include eye gaze information that identifies an area of the display screen being viewed by a person. The digital sign also includes logic to send the audience metrics to a remote system to identify a new content selection based on the audience metrics; and logic to render the new content selection on the display screen.

Example 32 includes the digital sign for rendering targeted content of example 31, including or excluding optional features. In this example, the new content selection is a musical selection identified as being popular with a demographic present in a vicinity of the digital sign as indicated by the audience metrics.

Example 33 includes the digital sign for rendering targeted content of any one of claims 31 to 32, including or excluding optional features. In this example, the new content selection is to be selected based on a portion of the display screen that is being viewed by a greater number of people.

Example 34 includes the digital sign for rendering targeted content of any one of claims 31 to 33, including or excluding optional features. In this example, the new content selection includes two or more advertisements to be displayed in different portions of the display screen, each advertisement identified as being likely to appeal to a group of people in a vicinity of the digital sign as indicated by the audience metrics.

Example 35 includes the digital sign for rendering targeted content of any one of claims 31 to 34, including or excluding optional features. In this example, the digital sign for rendering targeted content includes logic to identify a portion of the display screen not being viewed by anyone based on the eye gaze information and logic to render the new content selection in the portion of the display screen not being viewed by anyone.

Example 36 includes the digital sign for rendering targeted content of any one of claims 31 to 35, including or excluding optional features. In this example, the digital sign for rendering targeted content includes logic to measure a length of time that a portion of the display screen is viewed, wherein a level of interest is assigned for content displayed in the portion of the display screen based at least in part on the length of time.

Example 37 includes the digital sign for rendering targeted content of any one of claims 31 to 36, including or excluding optional features. In this example, the digital sign for rendering targeted content includes logic to render the new content selection and determine whether a targeted person shifts their gaze to the new content selection to determine whether the new content selection was successful at appealing to the targeted person.

Example 38 includes the digital sign for rendering targeted content of any one of claims 31 to 37, including or excluding optional features. In this example, the digital sign for rendering targeted content includes logic to record a number of views and a viewing time for each content selection rendered by the digital sign.

Example 39 includes the digital sign for rendering targeted content of any one of claims 31 to 38, including or excluding optional features. In this example, the new content selection is an advertisement related to content being displayed on a portion of the display screen and viewed by at least one person.

Example 40 includes the digital sign for rendering targeted content of any one of claims 31 to 39, including or excluding optional features. In this example, the digital sign for rendering targeted content includes logic to send the audience metrics to a data mining module residing on the remote system, wherein the data mining module identifies the new content selection based in part on previously collected audience metrics.

Example 41 is an apparatus for rendering targeted content. The apparatus includes instructions that direct the processor to means for rendering content on a display screen; means for receiving video images from a camera; and means for generating audience metrics based on the video images. The audience metrics include eye gaze information that identifies an area of the display screen being viewed by a person. The apparatus also includes means for receiving a new content selection based on the audience metrics; and means for rendering the new content selection on the display screen.

Example 42 includes the apparatus of example 41, including or excluding optional features. In this example, the new content selection is a musical selection identified as being popular with a demographic present in a vicinity of the digital sign as indicated by the audience metrics.

Example 43 includes the apparatus of any one of claims 41 to 42, including or excluding optional features. In this example, the new content selection is to be selected based on a portion of the display screen that is being viewed by a greater number of people as indicated by the audience metrics.

Example 44 includes the apparatus of any one of claims 41 to 43, including or excluding optional features. In this example, the new content selection includes two or more advertisements to be displayed in different portions of the display screen, each advertisement identified as being likely to appeal to a group of people in a vicinity of the digital sign as indicated by the audience metrics.

Example 45 includes the apparatus of any one of claims 41 to 44, including or excluding optional features. In this example, the apparatus includes means for identifying a portion of the display screen not being viewed by anyone based on the eye gaze information and rendering the new content selection in the portion of the display screen not being viewed by anyone.

Example 46 includes the apparatus of any one of claims 41 to 45, including or excluding optional features. In this example, the apparatus includes means for measuring a length of time that a portion of the display screen is viewed, and assigning a level of interest for content displayed in the portion of the display screen based at least in part on the length of time.

Example 47 includes the apparatus of any one of claims 41 to 46, including or excluding optional features. In this example, the apparatus includes means for rendering the new content selection and determining whether a targeted person shifts their gaze to the new content selection to determine whether the new content selection was successful at appealing to the targeted person.

Example 48 includes the apparatus of any one of claims 41 to 47, including or excluding optional features. In this example, the apparatus includes means for recording a number of views and a viewing time for each content selection rendered by the digital sign.

Example 49 includes the apparatus of any one of claims 41 to 48, including or excluding optional features. In this example, the new content selection is an advertisement related to content being displayed on a portion of the display screen and viewed by at least one person.

Example 50 includes the apparatus of any one of claims 41 to 49, including or excluding optional features. In this example, the apparatus includes means for sending the audience metrics to a data mining module residing on a remote system, wherein the data mining module identifies the new content selection based in part on previously collected audience metrics.

In the above description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a computer-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, described herein. The various appearances “an embodiment,” “one embodiment,” or “some embodiments” are not necessarily all referring to the same embodiments.

Not all components, features, structures, or characteristics described and illustrated herein are to be included in a particular embodiment or embodiments in every case. If the specification states a component, feature, structure, or characteristic “may”, “might”, “can” or “could” be included, for example, that particular component, feature, structure, or characteristic may not be included in every case. If the specification or claims refer to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein may not be arranged in the particular way illustrated and described herein. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A computer system, comprising:
a display screen;
a camera; and
a video analytics module to receive video images from the camera and generate audience metrics based on the video images, wherein the audience metrics include eye gaze information that identifies an area of the display screen being viewed by a person; and
a content management module to identify a content selection to be rendered by the digital sign based on the audience metrics.

2. The computer system of claim 1, wherein the content selection comprises a musical selection identified as being popular with a demographic present in a vicinity of the digital sign as indicated by the audience metrics.

3. The computer system of claim 1, wherein the content selection is to be selected based on a portion of the display screen that is being viewed by a greater number of people.

4. The computer system of claim 1, wherein the content selection comprises two or more advertisements to be displayed in different portions of the display screen, each advertisement identified as being likely to appeal to a group of people in a vicinity of the digital sign as indicated by the audience metrics.

5. The computer system of claim 1, wherein the digital sign is to identify a portion of the display screen not being viewed by anyone based on the eye gaze information and render the content selection in the portion of the display screen not being viewed.

6. The computer system of claim 1, wherein the computer system is to measure a length of time that a portion of the display screen is viewed and, based at least in part on the length of time, assign a level of interest in content being displayed in the portion of the display screen.

7. The computer system of claim 1, wherein the computer system is to render the content selection and determine whether a targeted person shifts their gaze to the content selection to determine whether the content selection was successful at appealing to the targeted person.

8. The computer system of claim 1, wherein the computer system is to record a number of views and a viewing time for each content selection rendered by the digital sign.

9. The computer system of claim 1, wherein the content selection is an advertisement related to content being displayed on a portion of the display screen.

10. The computer system of claim 1, wherein the video analytics module resides on the digital sign and the content management module resides on a remote computing system coupled to the digital sign through a network.

11. A non-transitory computer-readable medium comprising instructions to direct one or more processors of a digital sign to:
render content on a display screen;
receive video images from a camera;
generate audience metrics based on the video images, wherein the audience metrics include eye gaze information that identifies an area of the display screen being viewed by a person; and
send the audience metrics to a remote system to identify a new content selection based on the audience metrics; and
render the new content selection on the display screen.

12. The non-transitory computer-readable medium of claim 11, wherein the new content selection is a musical selection identified as being popular with a demographic present in a vicinity of the digital sign as indicated by the audience metrics.

13. The non-transitory computer-readable medium of claim 11, wherein the new content selection is to be selected based on a portion of the display screen that is being viewed by a greater number of people.

14. The non-transitory computer-readable medium of claim 11, wherein the new content selection comprises two or more advertisements to be displayed in different portions of the display screen, each advertisement identified as being likely to appeal to a group of people in a vicinity of the digital sign as indicated by the audience metrics.

15. The non-transitory computer-readable medium of claim 11, comprising instructions to identify a portion of the display screen not being viewed by anyone based on the eye gaze information and render the new content selection in the portion of the display screen not being viewed by anyone.

16. The non-transitory computer-readable medium of claim 11, comprising instructions to measure a length of time that a portion of the display screen is viewed, wherein a level of interest is assigned for content displayed in the portion of the display screen based at least in part on the length of time.

17. The non-transitory computer-readable medium of claim 11, comprising instructions to render the new content selection and determine whether a targeted person shifts their gaze to the new content selection to determine whether the new content selection was successful at appealing to the targeted person.

18. The non-transitory computer-readable medium of claim 11, comprising instructions to record a number of views and a viewing time for each content selection rendered by the digital sign.

19. The non-transitory computer-readable medium of claim 11, wherein the new content selection is an advertisement related to content being displayed on a portion of the display screen and viewed by at least one person.

20. The non-transitory computer-readable medium of claim 11, comprising instructions to send the audience metrics to a data mining module residing on the remote system, wherein the data mining module identifies the new content selection based in part on previously collected audience metrics.

21. A method of operating a digital sign, comprising:
rendering content on a display screen;
receiving video images from a camera;
generating audience metrics based on the video images, wherein the audience metrics include eye gaze information that identifies an area of the display screen being viewed by a person;
receiving a new content selection based on the audience metrics; and
rendering the new content selection on the display screen.

22. The method of claim 21, wherein the new content selection is a musical selection identified as being popular with a demographic present in a vicinity of the digital sign as indicated by the audience metrics.

23. The method of claim 21, wherein the new content selection is to be selected based on a portion of the display screen that is being viewed by a greater number of people as indicated by the audience metrics.

24. The method of claim 21, wherein the new content selection comprises two or more advertisements to be displayed in different portions of the display screen, each advertisement identified as being likely to appeal to a group of people in a vicinity of the digital sign as indicated by the audience metrics.

25. The method of claim 21, comprising identifying a portion of the display screen not being viewed by anyone based on the eye gaze information and rendering the new content selection in the portion of the display screen not being viewed by anyone.
